(19) United States
(12) Patent Application Publication
(10) Pub. No.: US 2026/0192922 A1
(43) Pub. Date: Jul. 9, 2026

(54) OVERHEAD CLAMP SYSTEM AND METHOD

(71) Applicant: Preformed Line Products Company, Cleveland, OH (US)

(72) Inventors: Ben Ciesielczyk, Madison, OH (US); Douglas Bell, Solon, OH (US); Nicholas Lees, Lakewood, OH (US); Craig Baldwin, Kirtland, OH (US)

(21) Appl. No.: 19/009,410

(22) Filed: Jan. 3, 2025

(51) Int. Cl. B64D 1/02; F16M 11/04; F16M 11/12; F16M 11/14

(52) U.S. Cl. CPC B64D 1/02; F16M 11/041; F16M 11/123; F16M 11/14

(57) ABSTRACT

A clamping system includes an overhead mount and a connecting rod fixed to the overhead mount through a universal joint. The connecting rod swings under gravity about the universal joint relative to the overhead mount. The clamping system also includes a clamp assembly fixed with the connecting rod.

### BACKGROUND

Bird diverters and line markers play crucial roles in reducing avian collisions and other accidents with power lines, a significant source of property damage and mortality for many bird species worldwide. Bird diverters are visual or tactile markers installed on power lines to enhance the visibility of the wires for birds, thereby reducing avian collisions with the power lines. In a similar manner, line markers make power lines more conspicuous to aircraft operators, especially under low visibility conditions such as fog, rain, or twilight.

Installing bird diverters and line markers on power lines is challenging due to the height of the lines and the large number of devices required, especially over extensive spans or in remote areas. Traditional methods, such as bucket trucks or climbing, are time-consuming, hazardous, and often impractical. Remotely operated drones provide a safer, faster, and more efficient alternative, allowing precise placement of devices without requiring direct worker access to the power lines. Drones not only mitigate risks to human workers but also improve the scalability and cost-effectiveness of deploying these essential conservation tools.

Operating drones to install bird diverters and line markers presents its own challenges, particularly due to the limitations of current clamping systems. These systems, which carry a single clamp for each bird diverter or line marker, often cause flight instability as they tend to wobble or otherwise disorient the drone in flight, impacting the drone's precision and control. Furthermore, replacing the clamping system after each loaded clamp is expended adds significant time and complexity to the operation, reducing overall efficiency.

### BRIEF DESCRIPTION

According to one aspect, a clamping system includes an overhead mount and a connecting rod fixed to the overhead mount through a universal joint. The connecting rod swings under gravity about the universal joint relative to the overhead mount. The clamping system also includes a clamp assembly fixed with the connecting rod.

According to another aspect, a method of operating a clamping system includes fixing an upper rod portion of a connecting rod to an overhead mount, fixing a lower rod portion of the connecting rod to a clamp assembly, and fixing the overhead mount to an overhead support. The method also includes driving the overhead support to a line including a cable, wire, or filament, wherein the connecting rod or the clamp assembly contact the line.

The innovation described herein describes an overhead clamping system that offers ease and efficiency in installing bird diverters and line markers on overhead lines, such as power lines or data transmission lines. In addition to other described features, functions, and benefits, the clamping system described herein, employed on a drone system, enables stabilized flight with relatively larger loads and reduced drone performance requirements.

### BRIEF DESCRIPTION OF THE DRAWINGS

FIG. 1 is a front perspective view of an example clamping system operated by a drone, in accordance with aspects of the innovation.

FIG. 2 is an enlarged, partial, front perspective view of the clamping system and the drone of FIG. 1.

FIG. 3 is an enlarged, partial front view of an overhead mount, a connecting rod, and a universal joint included in the clamping system of FIG. 1, where the universal joint is unbent and the connecting rod extends straight from the overhead mount.

FIG. 4 is an enlarged, partial front view of the overhead mount, the connecting rod, and the universal joint included in the clamping system of FIG. 1, where the universal joint is bent and the connecting rod extends at an angle from the overhead mount.

FIG. 5 is an enlarged, partial side perspective view of the connecting rod and the universal joint included in the clamping system of FIG. 1, engaged with a first coupling mechanism.

FIG. 6 is an enlarged, partial side view of the connecting rod and the universal joint included in the clamping system of FIG. 1, with the universal joint lifted and separated from the connecting rod.

FIG. 7 is a perspective view of the drone flying the clamping system of FIG. 1 toward a line.

FIG. 8 is an enlarged, partial front view of the connecting rod and a clamp assembly included in the clamping system of FIG. 1.

FIG. 9 is an enlarged, partial side view of the connecting rod and a clamp assembly included in the clamping system of FIG. 1.

FIG. 10 is a back perspective view of a first base portion included in the clamping system of FIG. 1.

FIG. 11 is an example process flow using the clamping system of FIG. 1.

FIG. 12 is a side perspective view of the clamping system operated by the drone of FIG. 1.

### DETAILED DESCRIPTION

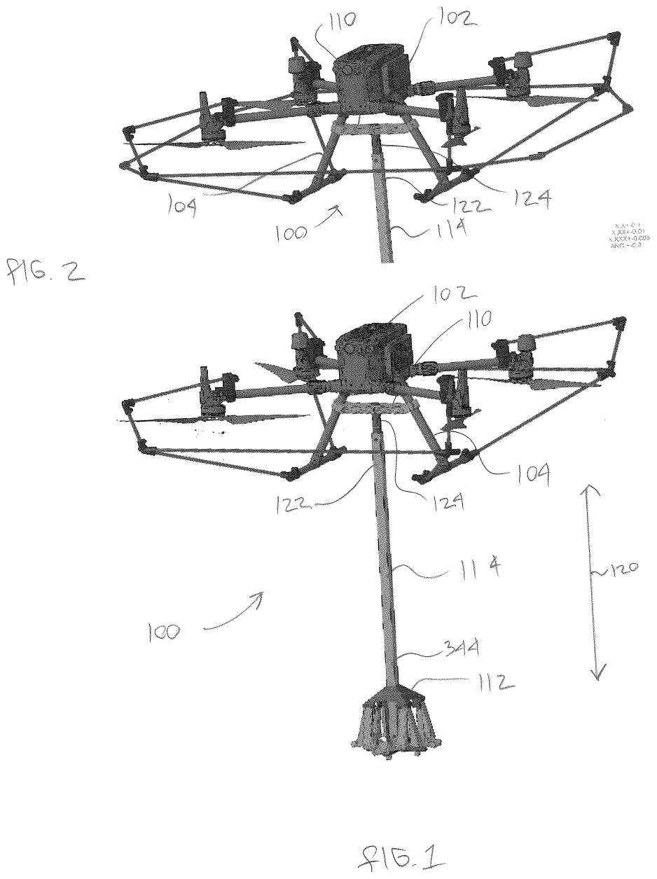

It should, of course, be understood that the description and drawings herein are merely illustrative and that various modifications and changes can be made in the structures disclosed without departing from spirit and scope the present disclosure. Referring now to the drawings, wherein like numerals refer to like parts throughout the several views, in accordance with an aspect of the innovation, FIG. 1 depicts an overhead clamping system 100 mounted to a drone 102 for deployment at a power line. More specifically, the drone 102 is an aerial drone that includes legs 104, and the clamping system 100 includes an overhead mount 110 fixed to the legs 104.

The clamping system 100 also includes a clamp assembly 112 pivotally fixed with the overhead mount 110 through a connecting rod 114. With this construction, when the drone 102 carries the clamping system 100 in flight as shown in FIG. 1, the clamping system 100 is in an upright position where the connecting rod 114 extends straight downward from the overhead mount 110 in a longitudinal direction aligned with gravity, indicated by an arrow 120, and aligns the clamp assembly 112 directly below the overhead mount 110. In an embodiment, the overhead mount 110, the connecting rod 114 and the clamp assembly 112 have centers of gravity that align with gravity through the connecting rod 114 in a vertical direction.

FIG. 2 depicts an enlarged view of the clamping system 100 at the drone 102. As shown in FIG. 2, an upper rod portion 122 of the connecting rod 114 is fixed to the overhead mount 110 via a universal joint 124. The universal joint 124 is configured to bend at least 90 degrees in any radial direction perpendicular to the longitudinal direction. With this construction, the connecting rod 114 is fixed to the overhead mount 110 through the universal joint 124, where the connecting rod 114 swings under gravity, toward the longitudinal direction, about the universal joint 124 relative to the overhead mount 110 and the drone 102. More specifically, when lifted by the drone 102, the clamp assembly 112 and the connecting rod 114 swivel or rotate under weight by gravity toward the upright position, at the universal joint 124, independent of an orientation of the drone 102 and the overhead mount 110.

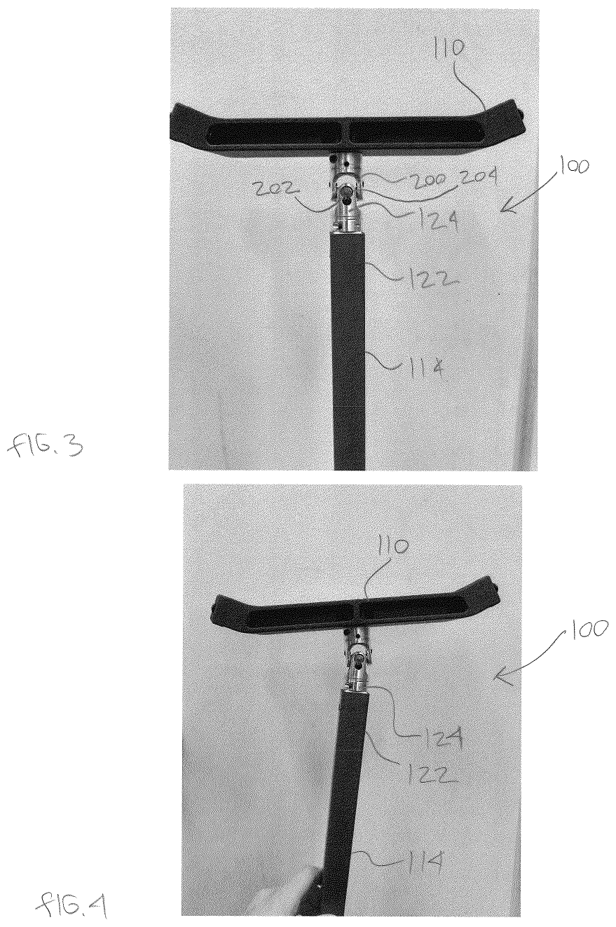

FIG. 3 depicts an enlarged view of the clamping system 100 at the universal joint 124. As shown in FIG. 3, the universal joint 124 is a double hinge joint, also referred to as a Cardan joint. In this regard, the universal joint 124 includes a first hinge 200 fixed with the overhead mount 110, and includes a second hinge 202 fixed with the upper rod portion 122. The first hinge 200 and the second hinge 202 are yokes connected to each other across a spider 204 in the universal joint 124. While, as depicted, the universal joint 124 is a double hinge joint, the universal joint 124 may additionally or alternatively include a Rzeppa joint, a ball joint, a gimbal joint, a Thomson coupling, a swivel joint, a flexible shaft coupling, or another structural, moment-releasing joint that directly couples the overhead mount to the connecting rod in mechanical connection, and is capable of bending at least 60 degrees in any radial direction of the clamping system 100 without departing from the scope of the present disclosure. In an embodiment, the universal joint 124 bends at least 90 degrees in any radial direction.

With this construction, as shown in FIG. 4, the connecting rod 114 may be reoriented from the overhead mount 110 (as compared to FIG. 3) without transferring a moment force across the universal joint 124. As such, the drone 102 may tilt, for example, in a given turn or acceleration maneuver while transporting the clamp assembly 112 to a power line without causing the clamp assembly 112 to also tilt. In this manner, the clamp system 100 stabilizes an orientation and position of the clamp assembly 112 directly below the drone 102 during transport.

Also, the connecting rod 114 may swing outward in any radial direction of the clamping system 100, and across any range of radial directions, for example during such transport, when the drone 102 performs a turning maneuver, without causing the drone 102 to also tilt. In this manner, the connecting rod 114 may swing independently of an orientation of the drone 102 in flight, isolating the drone 102 from the connecting rod 114 and the clamp assembly 112, and increasing flight control by the drone 102.

As such, the moment-releasing feature of the universal joint 124 also stabilizes flight control by the drone 102 by limiting rotational forces exerted from or across the connecting rod 114. With this construction, the drone 102 may carry relatively large loads while maintaining stable flight. Further, the drone 102 may employ a relatively small, portable design capable of carrying relatively large loads as momentum from the clamp assembly 112 and the connecting rod 114 is reduced through the universal joint 124.

Also, because swinging motion of the clamp assembly 112 and the connecting rod 114 is isolated from the drone 102 at the universal joint 124, the connecting rod 114 may be relatively elongated without imparting rotational forces on the drone 102. As described in greater detail below, a relatively elongated connecting rod 114 increases a target area of the clamping assembly 112 for contacting a power line, while maintaining distance and avoiding contact between the drone 102 and the power line.

In this manner, the universal joint 124 isolates rotational and swinging motions between the drone 102 and the connecting rod 114 in any radial direction. Because the universal joint 124 is a mechanical joint, the universal joint 124 does not consume power from the drone 102 or otherwise require a battery that would increase an overall load carried by the drone 102, reducing an overall required power usage by the drone 102 or increasing an overall flight capacity of the drone 102.

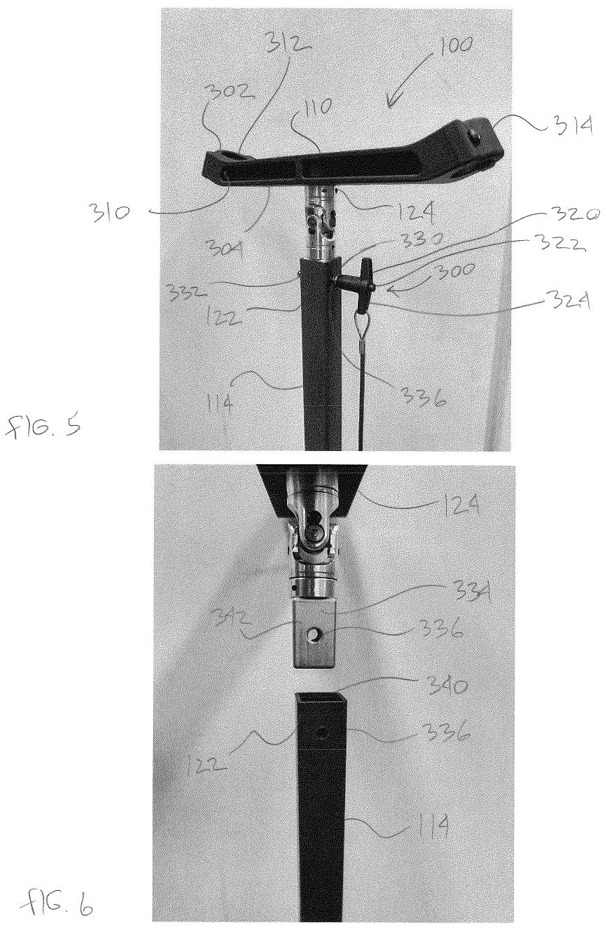

FIG. 5 depicts a perspective view of the clamping system 100, including the overhead mount 110 and a first coupling mechanism 300. As shown in FIG. 5, the overhead mount 110 includes a first collar 302 fixed with a main body portion 304 by a fastener 310. The first collar 302 and the main body portion 304, fixed together, define an opening 312 with an inner surface that is complementary to an outer surface of the legs 104 for holding the overhead mount 110 relative to the legs 104. In this manner, the first collar 302 receives one of the legs 104 and fixes the legs 104 to the overhead mount 110.

The overhead mount 110 includes a second collar 314 at a side of the main body portion 304. The second collar 314 includes similar features and functions in a similar manner as the first collar 302 for holding the overhead mount 110 relative to the legs 104, further description of which will be omitted here for the sake of brevity.

The first coupling mechanism 300 includes a first pin 320 extended through the connecting rod 114 and the universal joint 124, removably fixing the overhead mount 110 to the connecting rod 114 through the universal joint 124. The first pin 320 includes a first button 322 located on a first handle 324, where a user may actuate the first button 322 to drive a spindle through a first pin shaft 330, controlling displacement of first balls 332 at the first pin shaft 330. The first balls 332 extend outward from the first pin shaft 330 at a side of the connecting rod 114 and the universal joint 124 opposite the first button 322 and the first handle 324, and obstruct movement of the first pin shaft 330 through the connecting rod 114 and the universal joint 124 toward the first button 322 and the first handle 324.

The spindle inside the first pin shaft 330 maintains the first balls 332 extended outward from the first pin shaft 330 when the first button 322 is extended from the first handle 324 in an uncompressed state, and allows the first balls 332 to recede into the first pin shaft 330 when the first button 322 is compressed toward the first handle 324. A spring inside first pin shaft 330 biases the first button 322 outward from the first handle 324 in the uncompressed state. With this construction, a user may remove the first pin 320 from the connecting rod 114 and the universal joint 124 by pressing the button 322 toward the first handle 324 and pulling the first pin shaft 330 through the connecting rod 114 and the universal joint 124, toward the first handle 324.

With the first pin 320 removed from the connecting rod 114 and the universal joint 124, the connecting rod 114 may be removed from the universal joint 124 as shown in FIG. 6. In this regard, the universal joint 124 includes an upper insert 334, and the connecting rod 114 is a sleeve that receives the upper insert 334 at the upper rod portion 122. The upper insert 334 and the upper rod portion 122 define a first set of apertures 336 that align with each other in a radial direction when the connecting rod 114 is assembled with the universal joint 124 as shown in FIG. 5. With continued reference to FIG. 5, the first set of apertures 160 receive the first pin 320 in the radial direction, locking the connecting rod 114 with the universal joint 124 at the upper rod portion 122.

As shown in FIG. 6, the upper rod portion 122 includes an inner surface 340 that defines a recess extended in the longitudinal direction. The inner surface 340 extends straight downward in the longitudinal direction, and mates with an outer surface 342 of the upper insert 334 when the connecting rod 114 is locked with the universal joint 124. With this construction, the clamp assembly 112 and the control rod 114 are restricted from rotating about the longitudinal direction relative to the overhead mount 110 and the universal joint 124. The first set of apertures 336 at the upper rod portion 122 are through holes that extend in a radial direction to the inner surface 340, in the recess, from outside the upper rod portion 122.

Referring back to FIG. 1, the connecting rod 114 includes a lower rod portion 344 that extends opposite from the upper rod portion 122 in the longitudinal direction. More specifically, the upper rod portion 122 and the lower rod portion 344 extend straight from each other in opposite directions, and form a continuous profile in the connecting rod 114 in the longitudinal direction.

As such, the connecting rod 114 is elongated straight in the longitudinal direction from the upper rod portion 122 to the lower rod portion 344. With this construction, the connecting rod 114 extends straight downward with a continuous profile from the universal joint 124 to the clamp assembly 112, maximizing a target area for catching a power line.

In this regard, the drone 102 may maneuver the clamping system 100 to contact a power line at the connecting rod 114 between the universal joint 124 and the clamp assembly 112 in the longitudinal direction. Because the connecting rod 114 extends straight downward from the overhead mount 110, the drone 102 may guide the connecting rod 114 into contact with a power line from any radial direction.

When the connecting rod 114 contacts a power line, the drone 102 may increase altitude and contact the power line with the clamp assembly 112, actuating a clamp provided thereon. Alternatively, the drone 102 may directly drive the clamp assembly 112 into contact with a power line, actuating the clamp provided thereon.

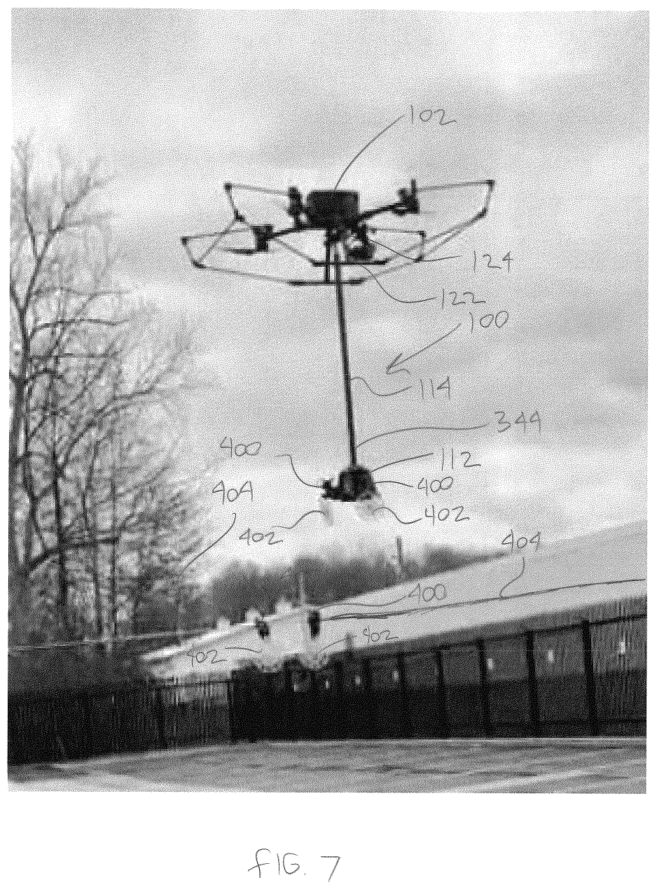

In this regard, FIG. 7 depicts example clamps 400 with line markers 402 mounted on the clamp assembly 112, carried by the drone 102, and engaged with an example power line 404. As depicted, the clamps 400 are mounted on the clamp assembly 112 facing outward from the connecting rod 114 in the radial direction. The clamps 400 fix the line markers 402 with the power line 404, and disengage the clamp assembly 112 when the drone 102 moves the clamping system 100 away from the power line 404.

The connecting rod 114 is elongated in the longitudinal direction to extend a target contact area of the clamping system 100 with respect to the power line 404. In the depicted embodiment, the power line 404 is a live, energized power line, and the connecting rod 114 is formed from a dielectric material that prevents electric current from the power line 404 from flowing to the drone 102. With this construction, the elongated connecting rod 114 extends the target contact area of the clamping assembly away from the drone 102, enabling the drone 102 to avoid contact with the power line 404. While, in the depicted embodiment, the power line 404 is an energized power line, the power line 404 may additionally or alternatively include a variety of wires, cables, filaments, and combinations thereof that impart structure, facilitate data transmission, or facilitate electric transmission without departing from the scope of the present disclosure.

The universal joint 124 enables the drone 102 to place the clamps 400 on the power line 404 without maintaining the connecting rod 114 in a vertical orientation. In this regard, the drone 102 may carry the upper rod portion 122 over and forward, past the power line 404 such that the power line 404 contacts the connecting rod 114 and pushes the lower rod portion 344 backward, causing the connecting rod 114 to swing from the vertical orientation at the universal joint 124. Then, as the drone 102 pulls the connecting rod 114 upward against the power line 404, the connecting rod 114 is allowed to pivot about the universal joint 124, maintaining contact with the power line 404, and maintaining an orientation of the clamp assembly 112 relative to the power line 404 such that one of the clamps 400 on the clamp assembly 112 receives and engages the power line 404.

FIG. 8 depicts an enlarged view of the clamp assembly 112, including a base 500 removably fixed with the lower rod portion 344 via a second coupling mechanism 502. The second coupling mechanism 502 includes similar features, and removably fixes the clamp assembly 112 with the lower rod portion 344 in a similar manner as the first coupling mechanism 300 removably fixes the universal joint 124 with the upper rod portion 122. In this regard, the second coupling mechanism 502 includes a second pin 504 extended through the base 500 and the connecting rod 114 at the lower rod portion 344, removably fixing the clamp assembly 112 to the connecting rod 114 at the lower rod portion 344.

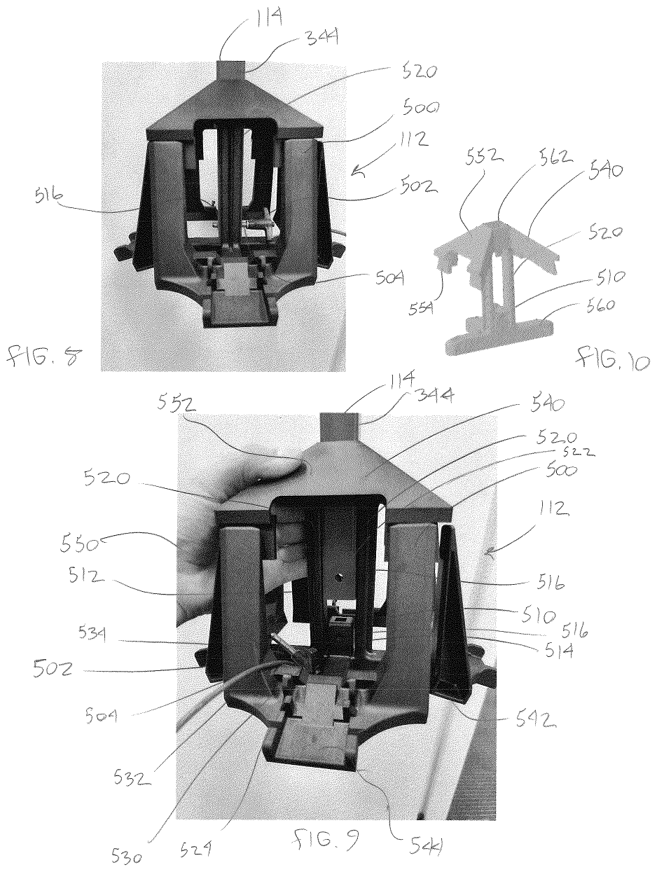

FIG. 9 depicts the second pin 504 removed from the base 500 and the lower rod portion 344, and the base 500 moved downward from the lower rod portion 344 as compared to FIG. 8. As shown in FIG. 9, with the second pin 504 removed from the connecting rod 114 and the clamp assembly 112, the clamp assembly 112 may be removed from the connecting rod 114.

With continued reference to FIG. 9, the clamp assembly 112 includes a lower insert 510, and the connecting rod 114 is a sleeve that receives the lower insert 510 at the lower rod portion 344 in the longitudinal direction. More specifically, the lower rod portion 344 includes an inner surface 512 that defines a recess extended in the longitudinal direction. The inner surface 512 extends straight upward in the longitudinal direction, and mates with an outer surface 514 of the lower insert 510 when the connecting rod 114 is locked with the base 500. With this construction, the clamp assembly 112 is restricted from rotating about the longitudinal direction relative to the control rod 114.

The lower insert 510 and the lower rod portion 344 define a second set of apertures 516 that align with each other in a radial direction when the connecting rod 114 is assembled with the base 500 shown in FIG. 8. With continued reference to FIG. 8, the second set of apertures 516 receive the second pin 504 in the radial direction, locking the connecting rod 114 with the clamp assembly 112 at the lower rod portion 344.

Referring back to FIG. 9, the clamp assembly 112 includes guardrails 520 that slide along an outer surface 522 of the lower rod portion 344 in the longitudinal direction when the connecting rod 114 is inserted through the base 500. In this manner, the guardrails 520 stabilize the base 500 on the lower rod portion 344, and reduce movement between the clamp assembly 112 and the connecting rod 114 to linear movement in the longitudinal direction. As such, the clamp assembly 112 is restricted from rotating around the longitudinal direction relative to the connecting rod 114 by both the guardrails 520 at the outer surface 522 of the lower rod portion 344, and the inner surface 512 of the lower rod portion 344.

The second set of apertures 516 at the lower rod portion 344 are through holes that extend in a radial direction to the inner surface 512, in the recess, from outside the lower rod portion 344. The second set of apertures 516 extend in a radial direction angularly offset from the guardrails 520. As such, the second set of apertures 516 are unobstructed by the guardrails 520, and do not otherwise require the guardrails 520 include openings for receiving the second pin 504.

With continued reference to FIG. 9, the second pin 504 includes a second button 524 located on a second handle 530, where a user may actuate the second button 524 to drive a spindle through a second pin shaft 532, controlling displacement of second balls 534 at the second pin shaft 532. The second balls 534 extend outward from the second pin shaft 532 at a side of the connecting rod 114 and the clamp assembly 112 opposite the second button 524 and the second handle 530, and obstruct movement of the second pin shaft 532 through the connecting rod 114 and the clamp assembly 112 toward the second button 524 and the second handle 530.

In this manner, the first coupling mechanism 300 and the second coupling mechanism 502 provide quick disconnect features that enable a user to attach and remove the base 500 or the connecting rod 114 from the drone 102 by hand, optionally without landing the drone 102. As such, a user operating the drone 102 may attach or remove the base 500 or the connecting rod 114 while the drone 102 remains in flight. With this construction, a user may employ a plurality of bases similar to or including the base 500, where each of the bases are preloaded with clamps, such as the clamps 190.

Also, while in the depicted embodiment the first coupling mechanism 300 and the second coupling mechanism 502 are quick-release pins that removably fix the overhead mount 110 and the clamp assembly 112 to the connecting rod 114, each of the first coupling mechanism 300 and the second coupling mechanism 502 may additionally or alternatively include pins such as dowel pins, taper pins, clevis pins, and split pins, may additionally or alternatively include threaded fittings such as bolts and nuts, and screws, may additionally or alternatively include latch mechanisms such as cam latches, spring latches, toggle latches, snap latches, may additionally or alternatively include clamps such as hose clamps, pipe clamps, C-clamps, and toggle clamps, may additionally or alternatively include quick-release fasteners, friction fit connections, magnetic couplings, clips, and hook and loop couplings such as J-hooks and hook-and-eye fasteners for removably fixing the overhead mount 110 and the clamp assembly 112 to the connecting rod 114, where the first coupling mechanism 300 and the second coupling mechanism 502 engage or disengage the overhead mount 110, the clamp assembly 112, and the connecting rod 114 by manual user operation without departing from the scope of the present disclosure.

The base 500 is formed from modular components fixed to each other on the lower rod portion 344. In this regard, with continued reference to FIG. 9, the base 500 includes a first base portion 540 supported on a second base portion 542. The second base portion 542 forms platforms 544 that each support one of the clamps 400 and corresponding line markers 402.

The second base portion 542 also forms vertical supports 550 that connect the platforms 544 to the first base portion 540. The vertical supports 550 clip to an overhang 552 formed from the first base portion 540. The overhang 552 extends radially outward from the guardrails 520 at the connecting rod 114.

FIG. 10 depicts the first base portion 540 separated from the remainder of the clamp assembly 112. As shown in FIG. 10, the first base portion 540 includes clips 554 formed in the overhang 552. The clips 554 receive and removably fix the vertical supports 550 with the first base portion 540.

The first base portion 540 includes base inserts 560 that extend underneath and support the platforms 544 from the lower rod portion 344. The first base portion 540 also includes the lower insert 510 extended straight upward in the longitudinal direction from the first base portion 540 at the base inserts 560. The first base portion 540 also includes the guardrails 520 extended in the longitudinal direction between the overhang 552 and the base inserts 560. The overhang 552, the guardrails 520, the base inserts 560, and the lower insert 510 are integrally formed with each other as parts of the first base portion 540.

The overhang 552 defines a through hole 562 that receives the lower rod portion 344 in the longitudinal direction, and guides the lower rod portion 344 toward the lower insert 510. In this regard, the through hole 562 is located between the guardrails 520 in a radial direction, and is aligned with the lower insert 510 in the longitudinal direction. With this construction, the lower rod portion 344 may be inserted into the through hole 562 along the guardrails 520, and locked with the lower insert 510. The first base portion 540 and the second base portion 542 may be removed from the lower rod portion 344 together or separately.

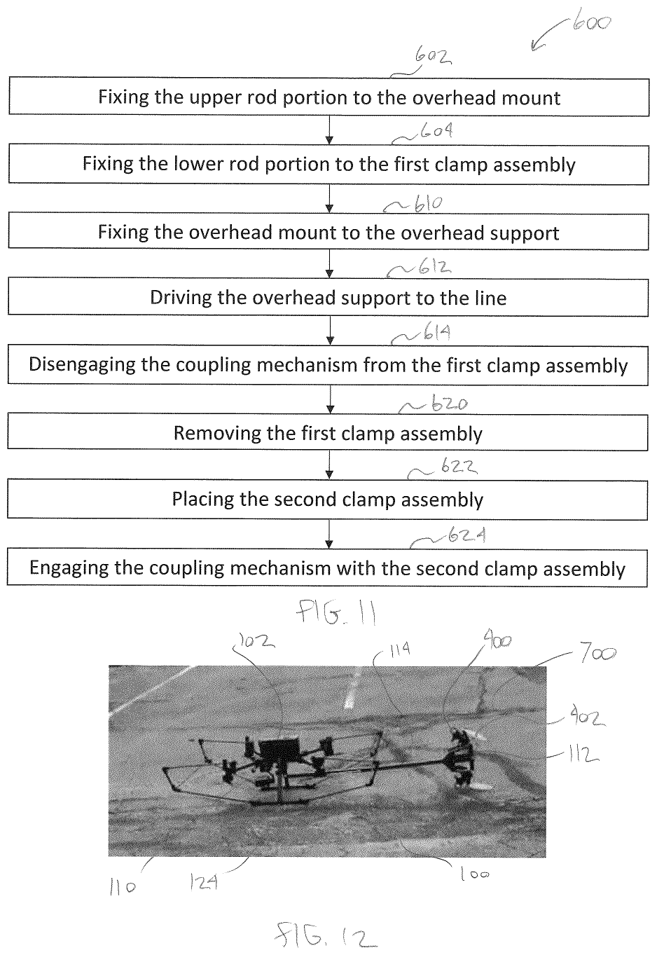

FIG. 11 depicts a method 600 for operating the clamping system 100, including assembling and using the clamping system 100. FIG. 11 will be described with reference to FIGS. 1-10 . For simplicity, the method 600 will be described with reference to a depicted sequence of blocks 602-624 which respectively correspond to steps in the method 600, but the elements of the method 600 may be organized in different orders, architectures, stages, and/or processes.

Referring to FIG. 11, at block 602 the method 600 includes fixing the upper rod portion 122 of the connecting rod 114 to the overhead mount 110. In an embodiment, fixing the upper rod portion 122 to the overhead mount 110 at block 602 includes removably fixing the upper rod portion 122 to the overhead mount 110 by manually engaging the first coupling mechanism 300 with the upper rod portion 122 and the overhead mount 110. In a further embodiment, fixing the upper rod portion 122 to the overhead mount 110 includes fixing the upper rod portion 122 to the overhead mount 110 through the universal joint 124, where the connecting rod 114 swings under gravity about the universal joint 124 relative to the overhead mount 110.

At block 604 the method 600 includes fixing a lower rod portion 344 of the connecting rod 114 to the clamp assembly 112. In an embodiment, fixing the lower rod portion 344 to the clamp assembly 112 includes removably fixing the lower rod portion 344 to the clamp assembly 112 by manually engaging the second coupling mechanism 502 with the lower rod portion 344 and the clamp assembly 112. In a further embodiment, the second coupling mechanism 502 is at least one of a pin, a threaded fitting, a latch mechanism, a clamp, a quick-release fastener, a clip, a magnetic coupling, or a hook and loop fastener.

At block 610 the method 600 includes fixing the overhead mount 110 to an overhead support. In an embodiment, the overhead support is the drone 102 including the legs 104. In this regard the drone 102 is an aerial drone that lifts the clamping system 100 to the upright position in flight.

At block 612 the method 600 includes driving the overhead support to a line including a cable, wire, or filament, wherein the connecting rod or the clamp assembly contact the line. In an embodiment, the line is the power line 404. In a further embodiment, as depicted in FIG. 12, driving the overhead support includes lifting the overhead support from a grounded position on a floor surface 700. In this regard, as shown in FIG. 12, the drone 102 is landed in the grounded position with the legs 104 on the floor surface 700.

With continued reference to FIG. 12, the connecting rod 114 is fixed with the overhead mount 110, and extends radially outward from the drone 102, along the floor surface 700 in the grounded position. The universal joint 124 accommodates the connecting rod 114 bending outward in any radial direction from the overhead mount 110 in the ground position. With this construction, the drone 102 may take off from, or land on the floor surface 700 without resting on the clamping system 100, including the overhead mount 110, the clamp assembly 112, or the connecting rod 114. With this construction, the drone 102 and the clamping system 100 do not require a specialized landing pad or other systems or equipment for takeoff and landing operations, and may be employed in a variety of field locations. In an embodiment, the universal joint 124 bends at least 60 degrees between the overhead mount 110 and the connecting rod 114 in the grounded position. In a further embodiment, the universal joint 124 bends at least 90 degrees between the overhead mount 110 and the connecting rod 114 in the grounded position.

As such, driving the overhead support at block 612 may include flying the drone 102, where the drone 102 lifts the clamping system 100, including the clamp assembly 112 from the floor surface 700 toward the line 404. As the drone 102 lifts the clamping system 100 from the floor surface 700 toward the upright position, the connecting rod 114 swings about the universal joint 124 downward under gravity at least 60 degrees from the grounded position along the floor surface 700 into the upright position.

Referring back to FIG. 11, at block 614, the clamp assembly 112 is a first clamp assembly, and the method 600 further includes disengaging the second coupling mechanism 502 from the first clamp assembly 112. At block 620 the method 600 includes removing the first clamp assembly 112 from the lower rod portion 344.

At block 622 the method 600 includes placing a second clamp assembly on the lower rod portion 344. In this regard, the second clamp assembly includes similar features and functions in a similar manner as the first clamp assembly 112 for supporting the clamps 400 and the line markers 402 on the lower rod portion 344, where the first clamp assembly 112 and the second clamp assembly are interchangeable in the clamping system 100.

At block 624 the method 600 includes engaging the second coupling mechanism 502 with the lower rod portion 344 and the second clamp assembly, removably fixing the second clamp assembly with the lower rod portion 344. In this manner, the clamp assembly 112 is replaceable and facilitates repeated use of the drone 102 for placing the clamps 400 and the line markers 402, without requiring that the clamp assembly 112 be reloaded with the clamps 400 and the line markers 402 immediately after each use.

Each of disengaging the second coupling mechanism 502 from the first clamp assembly 112 at block 614; removing the first clamp assembly 112 from the lower rod portion 344 at block 620; placing the second clamp assembly on the lower rod portion 344; and engaging the second coupling mechanism 502 with the lower rod portion 344 and the second clamp assembly may be performed while flying the drone 102. As such, the clamping system 100 does not require landing the drone 102 to replace the clamp assembly 112 and continue placing the clamps 400 and the line markers 402.

While, as depicted, the clamping system 100 is operated with the drone 102, the clamping system 100 may additionally or alternatively be operated by a variety of overhead systems from the overhead mount 110, such as a crane. Further, while as depicted the overhead mount 110 is fixed to the legs 104 of the drone 102, the overhead mount 110 may additionally or alternatively be fixed with an arm or other intermediate devices fixes to the drone 102 without departing from the scope of the present disclosure.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that various embodiments of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A clamping system, comprising:
an overhead mount;
a connecting rod fixed to the overhead mount through a universal joint, wherein the connecting rod swings under gravity about the universal joint relative to the overhead mount; and
a clamp assembly fixed with the connecting rod.

2. The system of claim 1, wherein the universal joint is a ball joint, a gimbal joint, a swivel joint, a flexible shaft coupling, a Thomson coupling, a Cardan Joint, or a Rzeppa joint.

3. The system of claim 1, wherein the universal joint is a structural, moment-releasing joint that directly couples the overhead mount to the connecting rod in mechanical connection.

4. The system of claim 1, wherein the connecting rod swings under gravity, toward a longitudinal direction, about the universal joint relative to the overhead mount, and the universal joint bends at least 60 degrees in any radial direction perpendicular to the longitudinal direction.

5. The system of claim 1, further comprising a coupling mechanism that removably fixes the overhead mount or the clamp assembly to the connecting rod.

6. The system of claim 5, wherein the coupling mechanism is a pin that extends through the connecting rod and the overhead mount or the clamp assembly.

7. The system of claim 6, wherein the overhead mount is fixed with the connecting rod at an upper rod portion,
the clamp assembly is fixed with the connecting rod at a lower rod portion extended opposite the upper rod portion in a longitudinal direction,
the clamp assembly includes a lower insert, and the connecting rod is a sleeve that receives the lower insert at the lower rod portion, in the longitudinal direction, and
the coupling mechanism extends through the lower rod portion and the lower insert in a radial direction perpendicular to the longitudinal direction.

8. The system of claim 5, wherein the coupling mechanism is at least one of a pin, a threaded fitting, a latch mechanism, a clamp, a quick-release fastener, a clip, a magnetic coupling, or a hook and loop fastener, and
the coupling mechanism engages or disengages the connecting rod with manual operation.

9. The system of claim 1, further comprising:
a first coupling mechanism that removably fixes the overhead mount to the connecting rod at an upper rod portion; and
a second coupling mechanism that removably fixes the clamp assembly to the connecting rod at a lower rod portion,
wherein the upper rod portion and the lower rod portion extend straight from each other in opposite directions.

10. The system of claim 1, wherein, in an upright position, the connecting rod extends straight downward from the overhead mount,
the clamp assembly is located directly below the overhead mount, and
the overhead mount, the connecting rod and the clamp assembly have centers of gravity that align with gravity through the connecting rod in a vertical direction.

11. The system of claim 1, wherein the overhead mount includes a collar
mount includes a collar fixed with a main body portion, wherein the collar receives an overhead support, and fixes the overhead support to the overhead mount.

12. The system of claim 1, wherein the overhead support is a leg of an aerial drone.

13. A method of operating a clamping system, the method comprising:
fixing an upper rod portion of a connecting rod to an overhead mount;
fixing a lower rod portion of the connecting rod to a clamp assembly;
fixing the overhead mount to an overhead support; and
driving the overhead support to a line including a cable, wire, or filament, wherein the connecting rod or the clamp assembly contact the line.

14. The method of claim 13, wherein fixing the lower rod portion to the clamp assembly includes removably fixing the lower rod portion to the clamp assembly by manually engaging a coupling mechanism with the lower rod portion and the clamp assembly, and the coupling mechanism is at least one of a pin, a threaded fitting, a latch mechanism, a clamp, a quick-release fastener, a clip, a magnetic coupling, or a hook and loop fastener.

15. The method of claim 14, wherein the clamp assembly is a first clamp assembly, and the method further comprises:
disengaging the coupling mechanism from the first clamp assembly;
removing the first clamp assembly from the lower rod portion;
placing a second clamp assembly on the lower rod portion; and
engaging the coupling mechanism with the lower rod portion and the second clamp assembly, removably fixing the second clamp assembly with the lower rod portion.

16. The method of claim 15, wherein the overhead support is an aerial drone, and driving the overhead support includes flying the aerial drone, and
each of disengaging the coupling mechanism from the first clamp assembly; removing the first clamp assembly from the lower rod portion; placing a second clamp assembly on the lower rod portion; and engaging the coupling mechanism with the lower rod portion and the second clamp assembly are performed while flying the aerial drone.

17. The method of claim 13, wherein fixing upper rod portion to the overhead mount includes removably fixing the upper rod portion to the overhead mount by manually engaging a coupling mechanism with the upper rod portion and the overhead mount.

18. The method of claim 13, wherein fixing the upper rod portion to the overhead mount includes fixing the upper rod portion to the overhead mount through a universal joint, wherein the connecting rod swings under gravity about the universal joint relative to the overhead mount.

19. The method of claim 18, wherein driving the overhead support includes lifting the overhead support from a grounded position on a floor surface,
the connecting rod extends along the floor surface in the grounded position, and
the universal joint bends at least 60 degrees between the overhead mount and the connecting rod in the grounded position.

20. The method of claim 13, wherein the overhead support is an aerial drone, and driving the overhead support includes flying the aerial drone, wherein the aerial drone lifts the clamp assembly from a floor surface toward the line, wherein the connecting rod swings under gravity at least 60 degrees from a grounded position along the floor surface to an upright position.
